(19) United States
(12) Patent Application Publication
(10) Pub. No.: US 2005/0223757 A1
(43) Pub. Date: Oct. 13, 2005

(54) Locking arrangement of a portable article such as computer processor casing to a work surface

(76) Inventor: Mair Avganim, Moshav Gealiya (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/507,433

(22) PCT Filed: Mar. 12, 2003
(86) PCT No.: PCT/IL03/00201

§ 371 Date: Sep. 10, 2004

(30) Foreign Application Priority Data
Mar. 13, 2002 (IL) 148661

(51) Int. Cl. E05B 73/00

(52) U.S. Cl. 70/58

(57) ABSTRACT

A locking arrangement for locking a portable article (16) such as miniature computer processor having a planar flat bottom surface to a stationary object such as table surface (10). At least a pair of first protrusions (22a-22d) are provided, each forming an undercut with respect to the bottom surface of the portable article (16), and an opening (24). A bar shaped locking substrate member (26) is provided comprising a bottom surface adapted to be placed on and fastened to the stationary object (10), and a top surface with at-least a pair of complementary undercut portions (32a-32d) configured to frictionally match the first protrusions (22a-22d) when the article is positioned overlapping the substrate member (26). Further provided is a key-operable rotatable lock member (36) carrying a projection (40) which is adapted to become inserted into the opening (24) in the overlapping position to thereby arrest the portable article (16) against the substrate member (10).

### FIELD OF THE INVENTION

The present invention relates to anti-theft locking arrangements. The invention particularly concerns the safeguarding of computer processor casings—although applicable to locking to a stationary object of other kinds of portable, easy to pick-up articles of value as will become apparent from the disclosure below.

### BACKGROUND OF THE INVENTION

Recent developments in the field of computer packaging is directed towards miniaturization. Laptop and palm-held computers, as well as flat screen monitors, are typical examples of this trend. In the not too far future, the traditional space-wasting desk computer casings will be replaced by processors the size of a cigar box. This will undoubtedly lead to a severe problem of snatching—not to speak of premeditated stealing—of the small-size, though expensive and valuable, devices.

The invention therefore aims at curing this undesirable result of modern computer packaging style and design.

### SUMMARY OF THE INVENTION

Proposed according to the invention at its broadest aspect is a locking arrangement for locking a portable article having a planar flat bottom surface to a stationary object, the arrangement comprising: At least a pair of first protrusions each forming an undercut with respect to the bottom surface; an opening formed at the bottom surface; a bar shaped substrate member comprising: a bottom surface adapted to be placed on and fastened to the stationary object; a top surface with at-least a pair of second protrusions each configured to frictionally fit over one of the first protrusions when the article is positioned on the substrate member; a key-operated rotatable lock member carrying a third protrusion which is adapted to become inserted by the rotation of the key into said opening in said frictionally fitting position to thereby arrest the portable article against the substrate member.

### BRIEF DESCRIPTION OF THE DRAWINGS

These and additional constructional features and advantages of the invention will be more clearly understood in the light of the ensuing description of preferred embodiments thereof, given by way of example only with reference to the accompanying drawings wherein—

FIG. 1 illustrates a typical working environment including a miniature computer processor casing;

FIG. 2 shows in perspective view a computer processor casing and a locking substrate member embodying the major features of the present invention;

FIG. 3 is a sectional view taken along line III-III of FIG. 2;

FIG. 4 is a sectional view taken along line IV-IV of FIG. 2; and

FIG. 5 shows a modified embodiment of the invention.

### DETAILED DESCRIPTION OF THE PREFERRED EMBODIMENTS

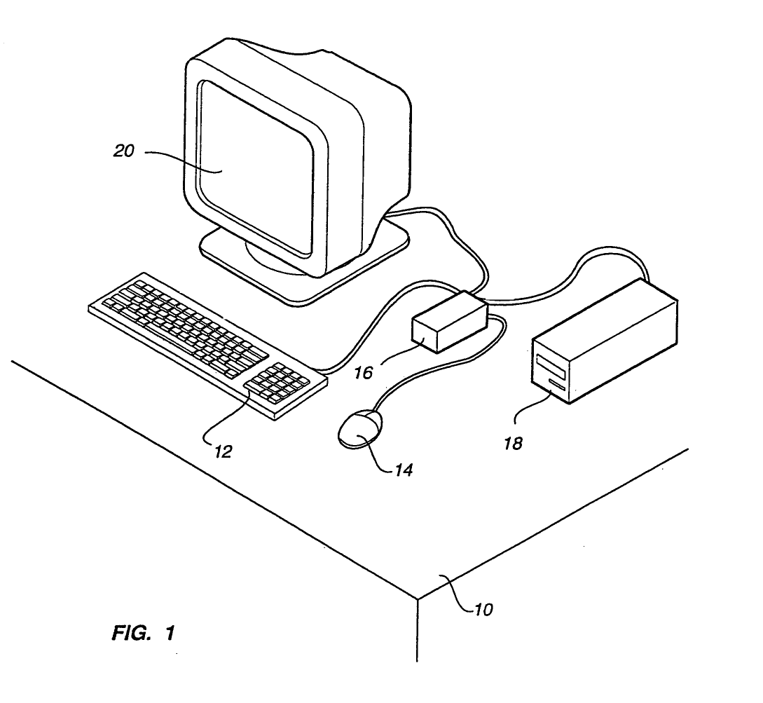

In FIG. 1, on working desk 10 there are placed keypad 12 and “mouse” 14 connected to a new age computer processor 16, namely replacing in all respects the traditional large and cumbersome desk-computer housing. Disk driver 18 and monitor 20 complete the typical computerized work station. The vulnerability of the processor 16 to casual or premeditated theft is quite obvious.

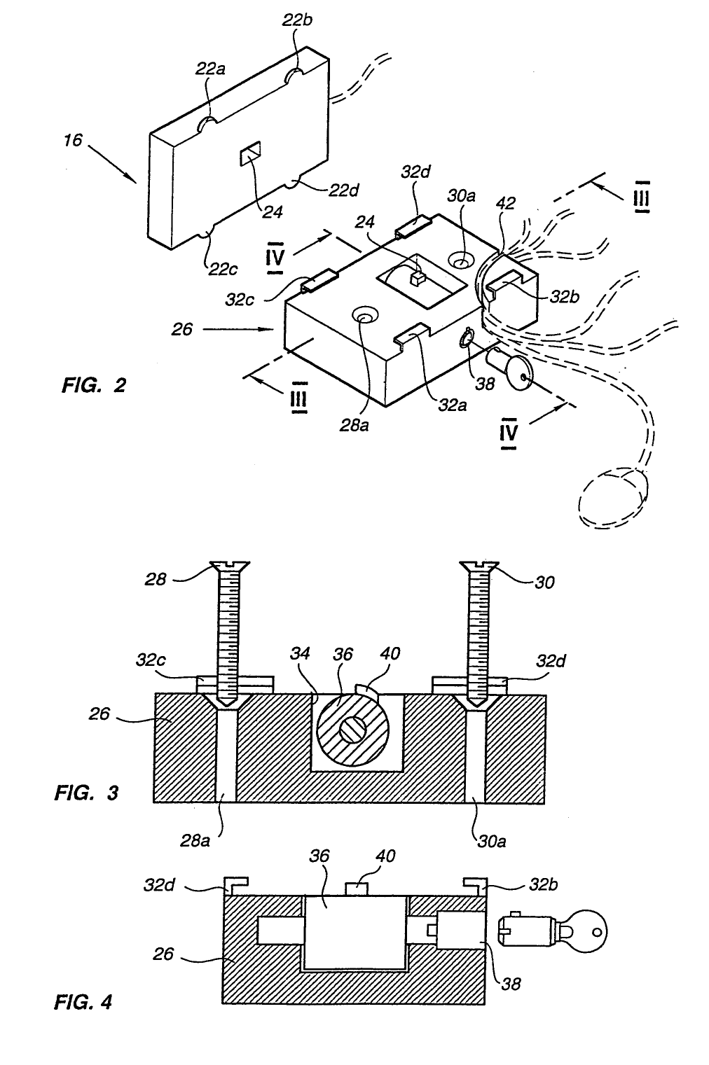

The solution proposed according to the present invention is to anchor the processor to the desk in a releasable fashion as to be now described with reference to FIGS. 2-4.

The processor casing 16 is provided, as one possibility out of many equivalent means or forms, with four tongue-like extensions 22a, 22b, 22c, and 22d merging out of the bottom wall thereof, thus forming an undercut with respect thereto.

Rectangular opening 24 is formed at the center (or anywhere else—see below) of the bottom wall.

A locking substrate member 26 is provided. It is in the shape of a bar or rail, made of cast aluminum, sintered metal, glass fiber reinforced plastics and the like, and is adapted to become secured to the work surface (such as table 10 of FIG. 1) by a pair of screws 28 and 30 passed through bores 28a and 30a.

The member 26 further comprises four L-shaped protrusions 32a, 32b, 32c and 32d configured to receive, by a sliding movement of the casing 16 over the upper surface of the locking substrate member 16, the extensions 22a, 22b, 22c and 22d, respectively, when reaching an overlapping position.

Within a cavity 34 formed for that purpose there is installed a cylindrical body 36. The body 36 is rotatable by being coupled to a key-operated locking mechanism 38 of any known type.

A projection 40 is carried by the cylinder 36 so that in the locked position of the mechanism 38 it becomes located in the 12 o'clock position, namely protruding above the upper surface of the member 26.

An elongated, deep slot 42 is preferably made at one or more corners of the substrate member 26, as shown.

The operation of the locking arrangement is as follows. Firstly, the locking substrate member 26 is fastened to the working surface by the screws 28 and 30. Then, the various cables (to the monitor, the “mouse”, the keypad and the disc-driver) are inserted into the slot 42 as shown in phantom lines in FIG. 2. The processor casing 16 is then engaged by sliding it over the member 26 until the extension 22 are received by the protrusions 32. The final locking is perfected by turning the cylinder 36 by the key so that the projection 40 enters the opening 24, thereby immobilizing the movement of the casing 16. In this fashion not only the casing 16 becomes secured but also (indirectly) the remaining accessories of the computer working station (FIG. 1).

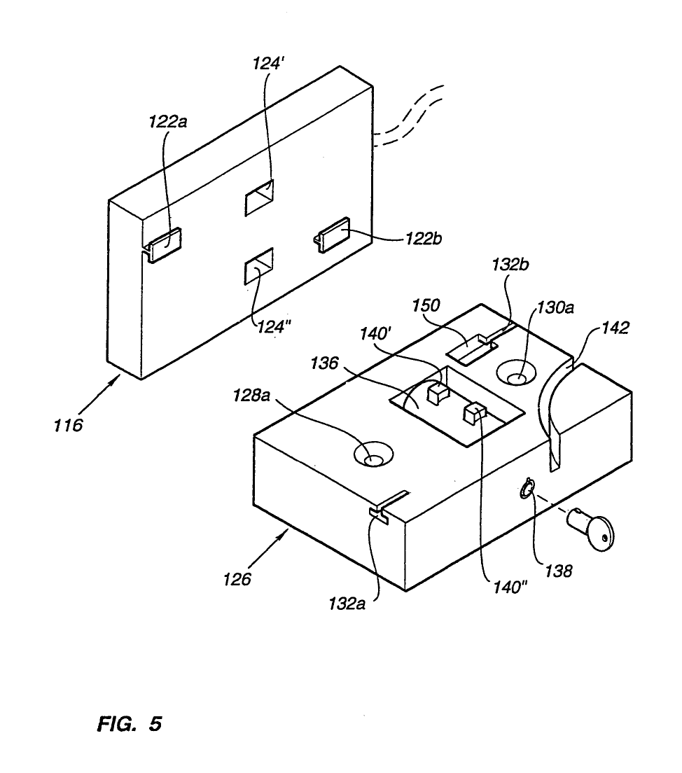

Obviously, the objectives of the invention can be achieved in various modified design details. Hence, as depicted in FIG. 5 (where similar reference numbers are used to denote parts and components corresponding to those of the previous embodiment), the computer processor casing 116 is provided with T-shaped projections 122a and 122b forming undercuts with respect to the bottom surface of the casing, and with two opening 124′ and 124″.

The locking substrate member 126 is formed with matching, T-shaped slots 132a and 132b (the latter also with an entrance recess 150 for enabling the sliding of the projection 122b into the slot 132b).

The mounting and securing procedure follows in the same manner as in the preceding embodiment.

Those skilled in the art to which this invention pertains will readily appreciate that numerous changes, variations and modifications can be effectuated without departing from the true spirit and scope of the invention as defined in and by the appended claims.

1. A locking arrangement for locking a portable article (16) having a planar flat bottom surface to a stationary object (10), the arrangement comprising:
(i) At least a pair of first protrusions (22a-22d) each forming an undercut with respect to the bottom surface of the portable article (16);
(ii) An opening (24) formed at the bottom surface of the portable article (16);
(iii) A bar shaped locking substrate member (26) comprising:—
(a) a bottom surface adapted to be placed on and fastened to the stationary object (10);
(b) a top surface with at-least a pair of complementary undercut portions (32a-32d) configured to frictionally match the first protrusions (22a-22d) when the article is positioned overlapping the substrate member (26);
(c) a key-operated rotatable lock member (36) carrying a projection (40) which is adapted to become inserted by the rotation of the key into said opening (24) in the overlapping position to thereby arrest the portable article (16) against the substrate member (10).

2. The locking arrangement as claimed in claim 1 wherein the said positioning of the article on the substrate member is gained by a sliding movement.

3. The locking arrangement as claimed in claim 2 wherein the first protrusions are in the form of extensions (22a-22d) coextensive with and directed away from the said bottom surface, and the complementary undercut portions (32a-32d) are L-shaped protrusions.

4. The locking arrangement as claimed in claim 2 wherein the first protrusions (122a; 122b) are T-shaped and the complementary undercut portions (132a; 132b) are in the form of T-shaped recesses extending along the top surface of the substrate member (126).

5. The locking arrangement as claimed in claim 1 wherein the substrate member is formed with a slot (42; 142) into which one or more cables can be laid for safeguarding other portable objects connected to the cable(s).

6. The locking arrangement as claimed in claim 1 wherein the portable article (16; 116) is a computer processor.
